(19) United States
(12) Patent Application Publication
(10) Pub. No.: US 2008/0118038 A1
(43) Pub. Date: May 22, 2008

(54) MEDIA GATEWAY TESTING DEVICE AND METHOD

(75) Inventor: CHU-FENG LIEN, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/938,309

(22) Filed: Nov. 12, 2007

(30) Foreign Application Priority Data
Nov. 17, 2006 (CN) 200610156910.4

(51) Int. Cl. H04M 1/24

(52) U.S. Cl. 379/26.01

(57) ABSTRACT

A media gateway testing device (10) is used for testing a media gateway. The media gateway testing device includes at least one calling module, an instruction module (161), a receiving module (162), a determining module (164), and a message producing module (165). The at least one calling module simulates at least one Voice over Internet Protocol phone. The instruction module sends a communication instruction to the at least one calling module. The at least one calling module executes the communication instruction to make the media gateway generate a communication request. The receiving module receives the communication request from the media gateway. The determining module determines whether the communication request received by the receiving module complies with a predefined protocol. The message producing module produces a message according to the determined result of the determining module.

### BACKGROUND OF THE INVENTION

1. Field of the Invention

The present invention relates to testing devices and methods, and particularly to a media gateway testing device and method.

2. Description of Related Art

Media gateways (MGs) are considered to be important components of the next generation network (NGN). Media gateways connect terminals to networks complying with a media gateway control protocol, for providing services such as network telephone and fax services. Nowadays, media gateway manufacturers test media gateways with media gateway controllers. However, media gateway controllers are expensive, and much complicated to operate in a test.

Therefore, a heretofore unaddressed need exists in the industry to overcome the aforementioned deficiencies and inadequacies.

### SUMMARY OF THE INVENTION

One aspect of the present invention provides a media gateway testing device. The media gateway testing device is used for testing a media gateway. The media gateway testing device includes at least one calling module, an instruction module, a receiving module, a determining module, and a message producing module. The at least one calling modules simulates at least one Voice over Internet Protocol phone. The instruction module sends a communication instruction to the at least one calling module. The at least one calling module executes the communication instruction to make the media gateway generate a communication request. The receiving module receives the communication request from the media gateway. The determining module determines whether the communication request received by the receiving module complies with a predefined protocol. The message producing module produces a message according to the determined result of the determining module.

Other objectives, advantages and novel features of the present invention will be drawn from the following detailed description of preferred embodiments of the present invention with the attached drawings, in which:

### BRIEF DESCRIPTION OF THE DRAWINGS

FIG. 1 is a block diagram of a media gateway testing device in accordance with an embodiment of the invention;

FIG. 2 is a flowchart of a media gateway testing method in accordance with another embodiment of the present invention; and

FIG. 3A to 3D are detailed flowcharts of the media gateway testing method of FIG. 2.

### DETAILED DESCRIPTION OF THE INVENTION

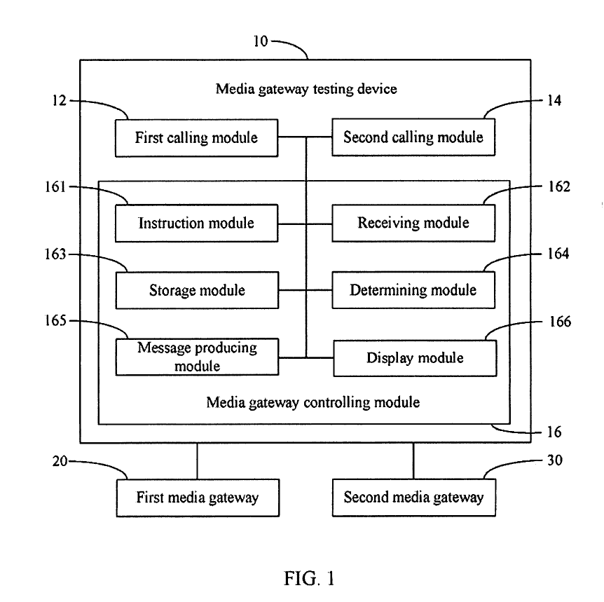

FIG. 1 is a block diagram of a media gateway testing device 10 in accordance with an embodiment of the invention.

The media gateway testing device 10 tests a first media gateway 20 and a second media gateway 30 to check whether the first media gateway 20 and the second media gateway 30 comply with a predefined protocol without use of phones and a media gateway controller. In this embodiment, the predefined protocol includes an H.248 protocol and a media gateway control protocol. The first media gateway 20 and the second media gateway 30 may be an access media gateway or a trunk media gateway.

The media gateway testing device 10 includes a first calling module 12, a second calling module 14, and a media gateway controlling module 16. In this embodiment, the first calling module 12 and the second calling module 14 simulate Voice over Internet Protocol (VoIP) phones.

The media gateway controlling module 16 controls the first calling module 12 and the second calling module 14 to test the first media gateway 20 and the second media gateway 30. The media gateway controlling module 16 includes an instruction module 161, a receiving module 162, a storage module 163, a determining module 164, a message producing module 165, and a display module 166.

The instruction module 161 sends communication instructions to the first calling module 12 and the second calling module 14. In this embodiment, the communication instructions include an off hook instruction, a dialing instruction, and an on hook instruction.

In this embodiment, the first calling module 12 and/or the second calling module 14 executes communication instructions sent by the instruction module 161 of the media gateway controlling module 16. The first media gateway 20 and/or the second media gateway 30 detect execution actions of the first calling module 12 and/or the second calling module 14, generate communication requests corresponding to the communication instructions, and send the communication requests to the media gateway controlling module 16. For example, when the first calling module 12 executes the off hook instruction, the first media gateway 20 will detect an off hook action of the first calling module 12 and generate an off hook request. Then, the first media gateway 20 sends the off hook request to the media gateway controlling module 16.

The receiving module 162 receives the communication requests from the first media gateway 20 and/or the second media gateway 30.

The storage module 163 stores predefined communication request information complying with the predefined protocol. In this embodiment, the predefined communication request information includes off hook request information, dialing request information, and on hook request information. The off hook request information, the dialing request information, and the on hook request information correspond to one off hook request, one dialing request, and one on hook request, respectively.

The determining module 164 determines whether the communication requests received by the receiving module 162 comply with the predefined protocol and whether the communication instructions are all sent out by the instruction module 161. In this embodiment, the determining module 164 compares each communication request received by the receiving module 162 with the communication request information stored in the storage module 163. If all communication requests are the same as the corresponding communication request information, the determining module 164 determines that the corresponding media gateway (the first media gateway 20 or the second media gateway 30) that transmits the communication request complies with the predefined protocol. If one communication request is not the same as the corresponding request information, the determining module 164 determines that the corresponding media gateway (the first media gateway 20 or the second media gateway 30) that transmits the communication request does not comply with the predefined protocol.

If the communication instruction sent from the instruction module 161 to the first calling module 12 is the on hook instruction, the determining module 164 determines that the communication instructions are all sent out by the instruction module 161. Otherwise, the determining module 164 determines that the communication instructions are not all sent out by the instruction module 161.

The message producing module 165 produces messages regarding the media gateways according to the determined result of the determining module 164. If the first media gateway 20 complies with the predefined protocol, the message producing module 165 produces a test passed message about the first media gateway 20. If the first media gateway 20 does not comply with the predefined protocol, the message producing module 165 produces a test failed message about the first media gateway 20. If the second media gateway 30 complies with the predefined protocol, the message producing module 165 produces a test passed message about the second media gateway 30. If the second media gateway 30 does not comply with the predefined protocol, the message producing module 165 produces a test failed message about the second media gateway 30. In this embodiment, the test result is displayed as a text. For example when the test result is a test passed message, then a text comprising a statement, such as “test passed” is displayed. In this embodiment, a test failed message includes the time when the test failure occurred and the media gateway that does not comply with the predefined protocol.

The display module 166 displays the messages produced by the message producing module 165. In this embodiment, the display module 166 is a liquid crystal display (LCD). In other embodiments, the display module 166 may be other types of display devices.

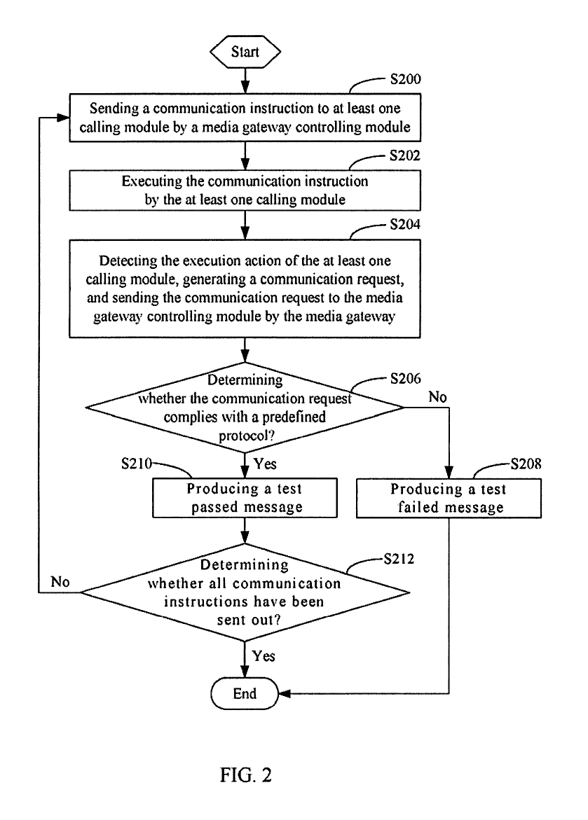

FIG. 2 is a flowchart of a media gateway testing method in accordance with another embodiment of the present invention.

In step S200, the media gateway controlling module 16 sends communication instructions to a plurality of calling modules. In this embodiment, the plurality of calling modules includes a first calling module 12 and a second calling module 14. The first calling module 12 simulates a calling party, and the second calling module 14 simulates a called party. In other embodiments, the second calling module 14 may simulate a calling party, and the first calling module 12 may simulate a called party. In this embodiment, the media gateway controlling module 16 initially sends an off hook instruction to the first calling module 12, sends a dialing instruction to the first calling module 12, then sends an off hook instruction to the second calling module 14, then sends an on hook instruction to the second calling module 14, then and sends an on hook instruction to the first calling module 12. After the media gateway controlling module 16 sends the on hook instruction to the first calling module 12, the test is ended.

In step S202, the plurality of calling modules execute the communication instructions.

In step S204, a plurality of media gateways detect the execution actions of the plurality of calling modules, generate communication requests, and send the communication requests to the media gateway controlling module. In this embodiment, the plurality of media gateways includes a first media gateway 20 and a second media gateway 30.

In step S206, the media gateway controlling module 16 determines whether the communication requests are correct. If the requests are incorrect, step S208 is next. If the requests are correct, step S210 is next.

In step S208, the message producing module 165 produces a test failed message indicating that the first media gateway 20 and/or the second media gateway 30 does not comply with the predefined protocol. The test failed message includes the time when the test failure occurred and the media gateway that does not comply with the predefined protocol. For example, the instruction module 161 sends an off hook instruction to the first calling module 12, and the first calling module 12 executes the off hook instruction. The first media gateway 20 detects an off hook action of the first calling module 12 and generates an off hook request corresponding to the off hook instruction. If the off hook request is not the same as the off hook request information, the first media gateway 20 does not comply with the predefined protocol, and the message producing module 165 produces the test failed message including the time when the test failed and the first media gateway 20 that does not comply with the predefined protocol.

In step S210, the message producing module 165 produces a test passed message. The test passed message indicates that the first media gateway 20 and the second media gateway 30 complies with the predefined protocol.

In step S212, the media gateway controlling module 16 determines whether the communication instructions are all sent out. If the communication instructions are all sent out, the media gateway testing device 10 ends the test. If the communication instructions are not all sent out, step S200 is next, the gateway testing device 10 tests the next communication instruction. In this embodiment, the last instruction sent by the instruction module 161 is an on hook instruction. When the determining module 164 determines the instruction sent from instruction module 161 to the first calling module 12 is an on hook instruction, then it is determined that all of the instructions have been sent out.

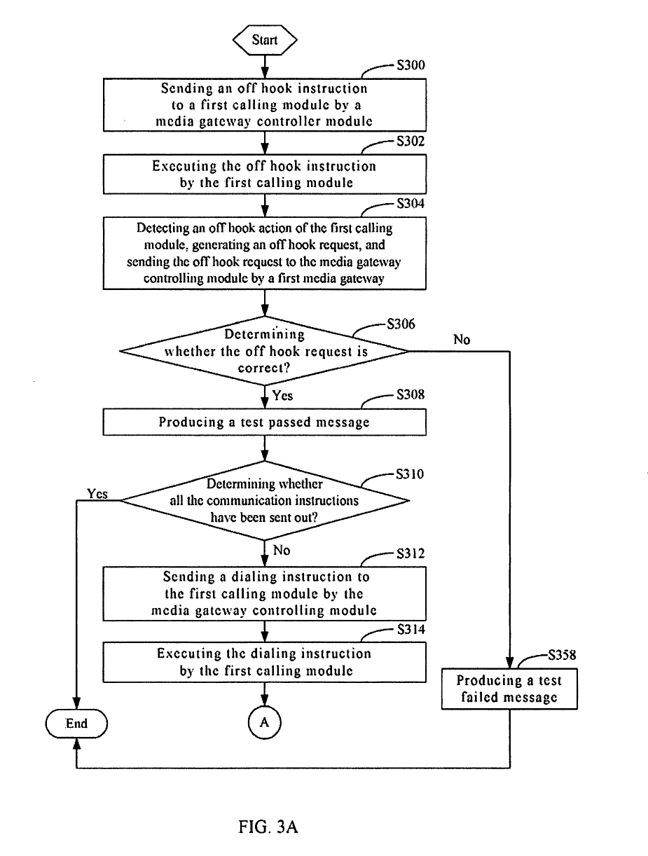

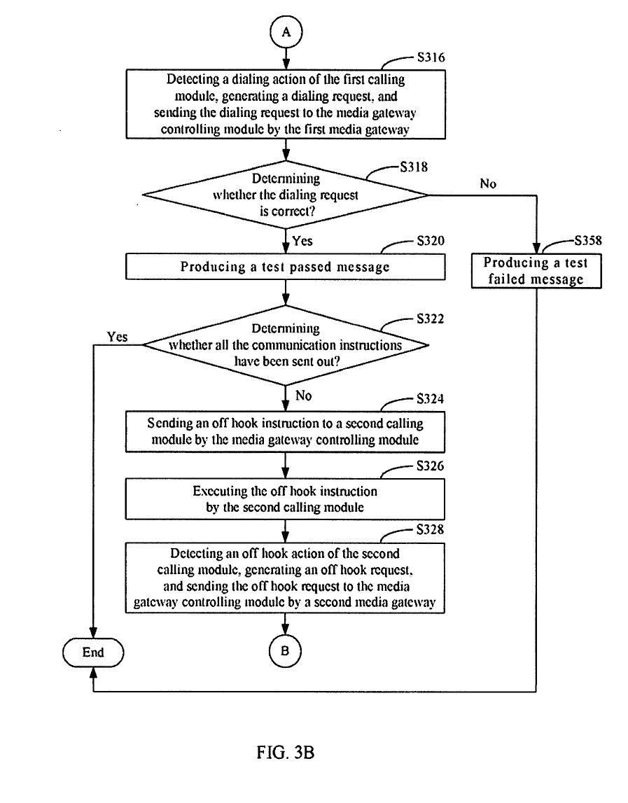

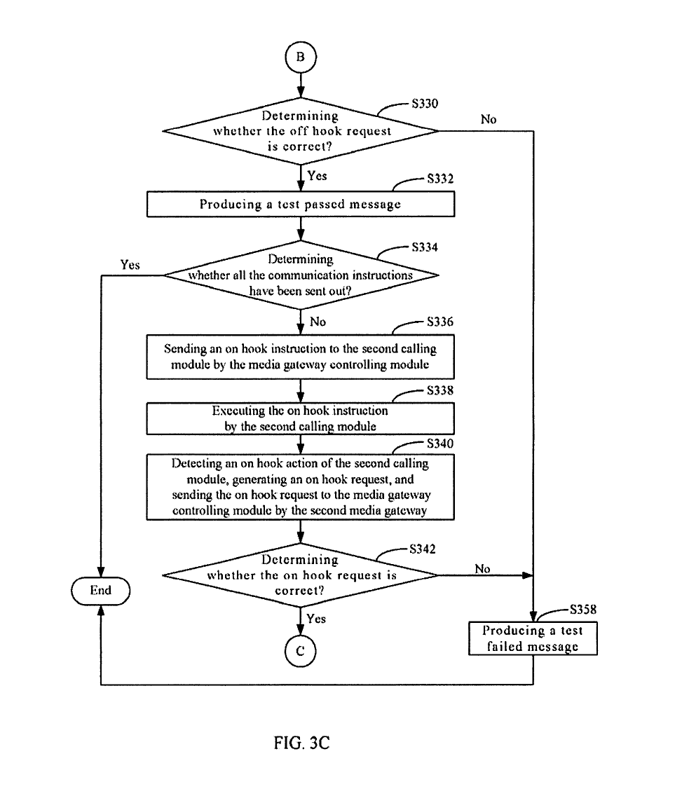

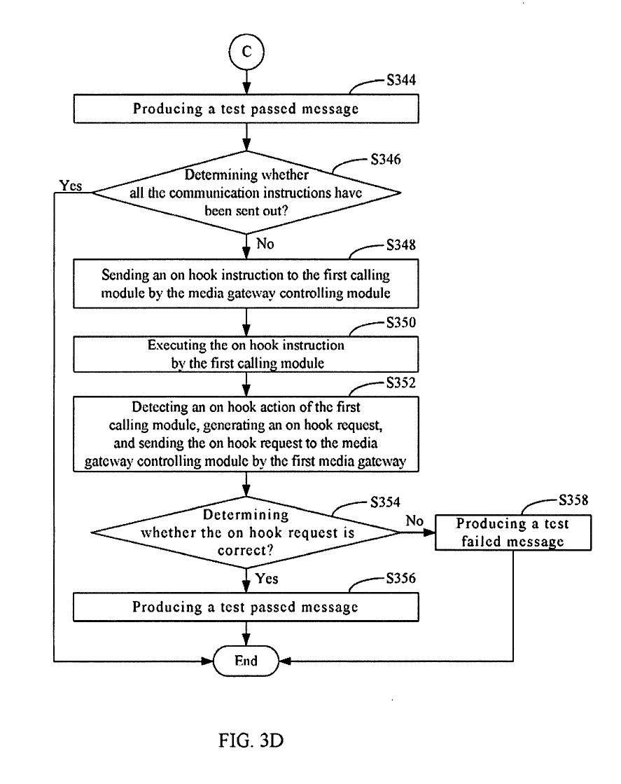

FIG. 3A to 3D are detailed flowcharts of the method of FIG. 2.

In step S300, the media gateway controlling module 16 sends an off hook instruction to the first calling module 12.

In step S302, the first calling module 12 executes the off hook instruction.

In step S304, the first media gateway 20 detects an off hook action of the first calling module 12, generates an off hook request, and sends the off hook request to the media gateway controlling module 16.

In step S306, the media gateway controlling module 16 determines whether the off hook request is correct. In this embodiment, the determining module 164 of the media gateway controlling module 16 compares the off hook request received by the receiving module 162 with the off hook request information stored in the storage module 163. If the off hook request is the same as the off hook request information, the determining module 164 determines that the off hook request is correct, step S308 is next. If the off hook request is incorrect, step S358 is next.

In step S308, the message producing module 165 produces a test passed message.

In step S310, the media gateway controlling module 16 determines whether all the communication instructions stored in the media gateway controlling module 16 have been sent out. If not all of the communication instructions have been sent out, step S312 is next. If all of the communication instructions have been sent out, the media gateway testing device 10 ends the test.

In step S312, the media gateway controlling module 16 sends a dialing instruction to the first calling module 12.

In step S314, the first calling module 12 executes the dialing instruction.

Referring to FIG. 3B, in step S316, the first media gateway 20 detects a dialing action of the first calling module 12, generates a dialing request, and sends the dialing request to the media gateway controlling module 16.

In step S318, the media gateway controlling module 16 determines whether the dialing request is correct. In this embodiment, the determining module 164 compares the dialing request received by the receiving module 162 with the dialing request information stored in the storage module 163. If the dialing request is the same as the dialing request information, the determining module 164 determines that the dialing request is correct, step S320 is next. If the dialing request is incorrect, step S358 is next.

In step S320, the message producing module 165 produces a test passed message.

In step S322, the media gateway controlling module 16 determines whether all the communication instructions stored in the media gateway controlling module 16 have been sent out. If not all of the communication instructions have been sent out, step S324 is next. If all of the communication instructions have been sent out, the media gateway testing device 10 ends the test.

In step S324, the media gateway controlling module 16 sends an off hook instruction to the second calling module 14.

In step S326, the second calling module 14 executes the off hook instruction.

In step S328, the second media gateway 30 detects an off hook action of the second calling module 14, generates an off hook request, and sends the off hook request to the media gateway controlling module 16.

Referring to FIG. 3C, in step S330, the media gateway controlling module 16 determines whether the off hook request is correct. In this embodiment, the determining module 164 compares the off hook request received by the receiving module 162 with the off hook request information stored in the storage module 163. If the off hook request is the same as the off hook request information, the determining module 164 determines that the off hook request is correct, step S332 is next. If the off hook request is incorrect, step S358 is next.

In step S332, the message producing module 165 produces a test passed message.

In step S334, the media gateway controlling module 16 determines whether all the communication instructions stored in the media gateway controlling module 16 have been sent out. If the communication instructions are not all sent out, step S336 is next. If the communication instructions are all sent out, the media gateway testing device 10 ends the test.

In step S336, the media gateway controlling module 16 sends an on hook instruction to the second calling module 14.

In step S338, the second calling module 14 executes the on hook instruction.

In step S340, the second media gateway 30 detects an on hook action of the second calling module 14, generates an on hook request, and sends the on hook request to the media gateway controlling module 16.

In step S342, the media gateway controlling module 16 determines whether the on hook request is correct. In this embodiment, the determining module 164 compares the on hook request received by the receiving module 162 with the on hook request information stored in the storage module 163. If the on hook request is the same as the on hook request information, the determining module 164 determines that the on hook request is correct, step S344 is next. If the on hook request is incorrect, step S358 is next.

In step S344, the message producing module 165 produces a test passed message.

In step S346, the media gateway controlling module 16 determines whether all the communication instructions stored in the media gateway controlling module 16 have been sent out. If not all of the communication instructions have been sent out, step S348 is next. If all of the communication instructions have been sent out, the media gateway testing device 10 ends the test.

In step S348, the media gateway controlling module 16 sends an on hook instruction to the first calling module 12.

In step S350, the first calling module 12 executes the on hook instruction.

In step S352, the first media gateway 20 detects an on hook action of the first calling module 12, generates an on hook request, and sends the on hook request to the media gateway controlling module 16.

In step S354, the media gateway controlling module 16 determines whether the on hook request is correct. In this embodiment, the determining module 164 compares the on hook request received by the receiving module 162 with the on hook request information stored in the storage module 163. If the on hook request is the same as the on hook request information, the determining module 164 determines that the on hook request is correct, step S356 is next. If the on hook request is incorrect, step S358 is next.

In step S356, the message producing module 165 produces a test passed message.

In step S358, the message producing module 165 produces a test failed message.

In the embodiment, the media gateway testing device 10 and the media gateway testing method can test the first media gateway 20 and the second media gateway 30 without a media gateway controlling module, which can cut cost of testing for the media gateway manufacturers.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A media gateway testing device for testing a media gateway, comprising:
at least one calling module for simulating at least one Voice over Internet Protocol (VoIP) phone;
an instruction module for sending a communication instruction to the at least one calling module, wherein the at least one calling module executes the communication instruction to make the media gateway generate a communication request;
a receiving module for receiving the communication request from the media gateway;
a determining module for determining whether the communication request received by the receiving module complies with a predefined protocol; and
a message producing module for producing a message according to the determined result of the determining module.

2. The media gateway testing device as recited in claim 1, wherein the determining module determines whether all the communication instructions have been sent out by the instruction module.

3. The media gateway testing device as recited in claim 1, further comprising:
a storage module for storing the predefined communication request information complying with a predefined protocol.

4. The media gateway testing device as recited in claim 3, wherein the predefined protocol comprises an H.248 protocol and a media gateway control protocol.

5. The media gateway testing device as recited in claim 3, further comprising a display module for displaying the messages produced by the message producing module.

6. The media gateway testing device as recited in claim 5, wherein the instruction module, the receiving module, the storage module, the determination module, the message producing module, and the display module are disposed in a media gateway controlling module.

7. A media gateway testing method, for testing at least one media gateway, comprising:
providing at least one calling module and a media gateway controlling module;
sending a communication instruction to the at least one calling module by the media gateway controlling module;
executing the communication instruction by the at least one calling module;
detecting an execution action of the at least one calling module, generating a communication request, and sending the communication request to the media gateway controlling module by the media gateway;
determining whether the communication request complies with a predefined protocol; and
producing a test passed message if the communication request complies with a predefined protocol.

8. The media gateway testing method as recited in claim 7, further comprising:
determining whether all communication instructions stored in the media gateway controlling module have been sent out; and
ending the test if all of the communication instructions are all sent out.

9. The media gateway testing method as recited in claim 8, wherein the at least one calling module comprises a first calling module and a second calling module, and the at least one media gateway comprises a first media gateway and a second media gateway.

10. The media gateway testing method as recited in claim 9, further comprising:
sending an off hook instruction to the first calling module by the media gateway controlling module;
executing the off hook instruction by the first calling module;
detecting an off hook action of the first calling module, generating an off hook request, and sending the off hook request to the media gateway controlling module by the first media gateway;
determining whether the off hook request is correct by the media gateway controlling module; and
producing a test passed message if the off hook request is correct.

11. The media gateway testing method as recited in claim 10, further comprising:
determining whether all the communication instructions stored in the media gateway controlling module have been sent out; and
ending the test if all the communication instructions have been sent out.

12. The media gateway testing method as recited in claim 1, further comprising:
sending a dialing instruction to the first calling module by the media gateway controlling module if not all the communication instructions have been sent out;
executing the dialing instruction by the first calling module;
detecting a dialing action of the first calling module, generating a dialing request, and sending the dialing request to the media gateway controlling module by the first media gateway;
determining whether the dialing request is correct by the media gateway controlling module; and
producing a test passed message if the dialing request is correct.

13. The media gateway testing method as recited in claim 12, further comprising:
determining whether all the communication instructions stored in the media gateway controlling module have been sent out; and
ending the test if all the communication instructions have been sent out.

14. The media gateway testing method as recited in claim 13, further comprising:
sending an off hook instruction to the second calling module by the media gateway controlling module if not all the communication instructions have been sent out;
executing the off hook instruction by the second calling module;
detecting an off hook action of the second calling module, generating an off hook request, and sending the off hook request to the media gateway controlling module by the second media gateway;
determining whether the off hook request is correct by the media gateway controlling module; and
producing a test passed message if the off hook request is correct.

15. The media gateway testing method as recited in claim 14, further comprising:
determining whether all the communication instructions stored in the media gateway controlling module have been sent out; and
ending the test if all the communication instructions have been sent out.

16. The media gateway testing method as recited in claim 15, further comprising:
sending an on hook instruction to the second calling module by the media gateway controlling module if not all the communication instructions have been sent out;
executing the on hook instruction by the second calling module;
detecting an on hook action of the second calling module, generating an on hook request, and sending the on hook request to the media gateway controlling module by the second media gateway;
determining whether the on hook request is correct by the media gateway controlling module; and
producing a test passed message if the on hook request is correct.

17. The media gateway testing method as recited in claim 16, further comprising:
determining whether all the communication instructions stored in the media gateway controlling module have been sent out; and
ending the test if all the communication instructions have been sent out.

18. The media gateway testing method as recited in claim 17, further comprising:
sending an on hook instruction to the first calling module by the media gateway controlling module if not all the communication instructions have been sent out;
executing the on hook instruction by the first calling module;
detecting an on hook action of the first calling module, generating an on hook request, and sending the on hook request to the media gateway controlling module by the first media gateway;
determining whether the on hook request is correct by the media gateway controlling module; and
producing a test passed message if the on hook request is correct.

19. A network apparatus testing device for testing a network apparatus, comprising:
at least one calling module for simulating at least one Voice over Internet Protocol (VoIP) phone;
an instruction module for sending a communication instruction to the at least one calling module, wherein the at least one calling module executes the communication instruction to make the network apparatus generate a communication request;
a receiving module for receiving the communication request from the network apparatus;
a determining module for determining whether the communication request received by the receiving module complies with a predefined protocol; and
a message producing module for producing a message according to the determined result of the determining module.
